(19) United States
(12) Patent Application Publication
(10) Pub. No.: US 2011/0139621 A1
(43) Pub. Date: Jun. 16, 2011

(54) MICROFLUIDIC CELL

(76) Inventors: Michael Stumber, Korntal-Muenchingen (DE); Martina Daub, Weissach (DE); Jochen Rupp, Stuttgart (DE); Massimo Kubon, Muensingen-Rietheim (DE); Peter Rothacher, Bruchsal (DE); Meike Moschallski, Reutlingen-Ohmenhausen (DE); Martin Stelzle, Reutlingen (DE); Christian Dorrer, Stuttgart (DE)

(21) Appl. No.: 12/853,920

(22) Filed: Aug. 10, 2010

(30) Foreign Application Priority Data
Aug. 13, 2009 (DE) 10 2009 028 496.6

(51) Int. Cl. G01N 27/453; G01N 27/447

(52) U.S. Cl. 204/451; 204/601

(57) ABSTRACT

A microfluidic cell for the dielectrophoretic separation, accumulation, and/or lysis of polarizable bioparticles, including an interdigital electrode system composed of two electrode groups having interdigitated electrodes, a flat electrode in which the interdigital electrode system and the flat electrode are situated on opposite sides of the cell in order to improve the separation, accumulation and/or lysis characteristics. Moreover, a microfluidic system which includes such a microfluidic cell, and use thereof, and a method for separating, accumulating, and/or lysing polarizable bioparticles is also described.

### RELATED APPLICATION INFORMATION

The present application claims priority to and the benefit of German patent application no. 10 2009 028 496.6, which was filed in Germany on Aug. 13, 2009, the disclosure of which is incorporated herein by reference.

### FIELD OF THE INVENTION

The present invention relates to a microfluidic cell, a microfluidic system, use of the microfluidic cell and microfluidic system, and a method for separating, accumulating, and/or lysing polarizable bioparticles.

### BACKGROUND INFORMATION

Microfluidic cells for the dielectrophoretic accumulation of bioparticles exist which have an interdigital electrode system. For the accumulation, an alternating voltage is applied to the interdigital electrode system, and a suspension containing bioparticles is pumped through the cell. The bioparticles may be collected on the interdigital electrode system by positive dielectrophoresis (pDEP) and the bioparticles may be repelled by negative dielectrophoresis (nDEP).

A system for dielectrophoretic accumulation is discussed in the publication “Microdevices for Dielectrophoretic Flow-Through Cell Separation” (D. Holmes, N. Green, H. Morgan IEEE Eng. Med. Biol. 2003, 22, 85-90). The described system exhibits interdigitated electrodes both on the bottom and on top of the cell.

### SUMMARY OF THE INVENTION

The subject matter of the present invention is a microfluidic cell, in particular a flow cell, in particular for the dielectrophoretic separation and/or accumulation and/or lysis of polarizable bioparticles, for example bacteria and/or cells and/or viruses, the microfluidic cell including an interdigital electrode system composed of two electrode groups having interdigitated electrodes and a flat electrode, the interdigital electrode system and the flat electrode being situated on the opposite sides of the cell.

An interdigital electrode system composed of two electrode groups having electrodes which are situated in an interdigitated manner may in particular be an electrode system composed of two comb-like/finger-like electrodes which are mutually engaged, in particular in an alternating manner (“interdigitated electrodes” (IDE)). The electrodes of the interdigital electrode system may be formed and situated in the form of parallel, straight strips.

A flat electrode may be an electrode, in particular, having a continuous/uninterrupted planar surface.

Using the microfluidic cell according to the present invention, polarizable bioparticles such as bacteria, cells, or viruses may be advantageously accumulated from a sample liquid flowing past and concentrated. A high yield of accumulated bioparticles and/or a high sample throughput, for example several milliliters of sample liquid within 30 to 60 minutes, may be achieved. The accumulated bioparticles may then optionally be lysed in the cell. The microfluidic cell may be advantageously integrated into a microfluidic “lab-on-a-chip” system.

Using a flat electrode may have the advantage that it needs to be only roughly adjusted with respect to the interdigital electrode system, thus allowing the assembly of the cell to be simplified. Therefore, the flat electrode may improve the accumulation efficiency of the cell, even if the flat electrode is kept in a floating state by the voltage during the accumulation. In addition, the flat electrode may improve the lysis. By applying an, in particular positive, voltage to the flat electrode, also agglomerated bioparticles, in particular DNA, may be dislodged and moved toward the flat electrode, and thus to the central region of the cell. In this way the accumulated bioparticles may advantageously be better or more completely rinsed out.

For example, the flat electrode may be situated on the cover of the cell. The “cover” of the cell may be understood in particular to mean the surface which in operating mode is situated at the top, in particular with respect to the direction of gravity.

The flat electrode may completely span the interdigital electrode system.

Within the scope of a specific embodiment of the present invention, the surface of the flat electrode essentially corresponds to the surface of the interdigital electrode system. “Essentially” means that the surface areas may differ from one another by less than 10%.

Within the scope of another specific embodiment of the present invention, the cell further includes a micromixer having microchannels and microelevations. In this way, the polarizable bioparticles entering the cell far from the electrodes of the interdigital electrode system may be brought close to the electrodes of the interdigital electrode system on their way through the cell, to be detected there by the electric field between the electrodes and the interdigital electrode system.

Within the scope of another specific embodiment of the present invention, the interdigital electrode system and the micromixer are situated on the same side of the cell. The flat electrode in particular is situated on a side of the cell opposite from the side on which the interdigital electrode system and the micromixer are situated. The flow in the region of the interdigital electrode system may be advantageously calmed due to the fact that the micromixer is situated on the same side of the cell as the interdigital electrode system. Accumulated bioparticles may thus be advantageously prevented from being washed out again during the accumulation.

The interdigital electrode system and the micromixer may be situated on the bottom of the cell. The “bottom” of the cell may be understood to mean in particular the surface which in operating mode is situated at the bottom, in particular with respect to the direction of gravity.

Within the scope of another specific embodiment of the present invention, electrodes of the interdigital electrode system are situated in the microchannels. In this way, the interdigital electrode system and the micromixer may advantageously form a combined interdigital electrode-micromixer system. Such a combined interdigital electrode-micromixer system may advantageously have a particularly good flow calming effect in the region of the electrodes of the interdigital electrode system. In particular, one electrode of the interdigital electrode system may be situated in each microchannel of the micromixer.

Within the scope of another specific embodiment of the present invention, the surface area of the flat electrode essentially corresponds to the surface area of the combined interdigital electrode-micromixer system. “Essentially” means that the surface areas may differ from one another by less than 10%.

Within the scope of another specific embodiment of the present invention, the micromixer, in particular the microelevations of the micromixer, is/are made of an insulating material, for example a plastic or a polymer, for example a photoresist, a polycarbonate, or a solder resist. In this way the micromixer is advantageously able to alter the field distribution in the cell in such a way that a more efficient accumulation is made possible. For example, the field lines in the narrow sections of the cell may be focused, as the result of which additional inhomogeneity of the electrical field may be provided, and/or the dielectrophoretic force is able to act farther inside the cell.

Within the scope of another specific embodiment of the present invention, the electrodes of the interdigital electrode system and/or the microchannels and/or the microelevations are configured and situated in parallel.

In another specific embodiment of the present invention, the electrodes of the interdigital electrode system and/or the microchannels and/or the microelevations are configured and situated at an angle α of ≧20° to ≦70°, in particular of ≧40° to ≦50°, with respect to the flow direction.

Within the scope of another specific embodiment of the present invention, the electrodes of the interdigital electrode system and/or the microchannels and/or the microelevations are configured and situated in a zigzag shape, for example a zigzag shape having equal angles or a zigzag shape having unequal angles, in particular in the shape of a symmetrical or asymmetrical herringbone pattern, or in the shape of a parallel slash mark pattern, in particular an equidistant parallel slash mark pattern.

The cell may have an inlet and an outlet. The interdigital electrode system and/or the micromixer, in particular the combined interdigital electrode-micromixer system, and/or the flat electrode may be situated in an area between the inlet and the outlet. The cell may be connected to a pump and/or to a sample inlet reservoir via the inlet. The outlet may be connected to a sample collection reservoir and/or to a waste reservoir.

Within the scope of another specific embodiment of the present invention, the cell includes at least one further interdigital electrode system composed of two electrode groups having interdigitated electrodes, and/or one further micromixer having microchannels and microelevations, in particular a further combined interdigital electrode-micromixer-system. The cell may include another flat electrode. The first interdigital electrode system and the first flat electrode may be situated on opposite sides of the cells, and the further interdigital electrode system and the further flat electrode may also be situated on opposite sides of the cells, in particular, on the same side each as the first interdigital electrode system and the first flat electrode respectively. However, it is also possible for the (first) flat electrode to span over the other interdigital electrode system and/or the further micromixer having microchannels and microelevations, in particular, the further combined interdigital electrode-micromixer-system. The further interdigital electrode system and/or the further micromixer, in particular the further combined interdigital electrode-micromixer system, may be spaced apart, for example by the distance from the previous interdigital electrode system and/or the previous micromixer, in particular the previous combined interdigital electrode-micromixer system. The further interdigital electrode system and/or the further micromixer, in particular the further combined interdigital electrode-micromixer system, may has/have a configuration which is different, in particular with regard to the shape and orientation, from the previous interdigital electrode system and/or the previous micromixer, in particular the previous combined interdigital electrode-micromixer system. The surface area of the flat electrode may essentially correspond to the total surface areas of the interdigital electrode system, in particular the combined interdigital electrode-micromixer-system and the spaced apart surface areas. “Essentially” means that the surface areas may differ from one another by less than 10%.

The micromixer and the interdigital electrode system, in particular the combined interdigital electrode-micromixer system, may have a length (L) of ≧10 mm to ≦60 mm, in particular of ≧20 mm to ≦50 mm, for example 40 mm, and/or a width (B) of ≧3 mm to ≦30 mm, in particular of ≧5 mm to ≦10 mm, for example 6 mm, and/or a surface area (L×B) of ≧30 mm² to ≦1800 mm², in particular ≧100 mm² to ≦300 mm², for example 6 mm×40 mm.

The distance (d) between two microchannels may be between ≧30 μm and ≦500 μm, in particular between ≧50 μm and ≦200 μm, for example 100 μm. In other words, the microelevations may have a width (B2b) of ≧30 μm to ≦500 μm, in particular of ≧50 μm to ≦200 μm, for example 100 μm. The microelevations may also have a height (H2) of ≧10 μm to ≦400 μm, in particular of ≧20 μm to ≦50 μm, for example 30 μm. In other words, the microchannels may have a depth (T2) of ≧10 μm to ≦400 μm, in particular of ≧20 μm to ≦50 μm, for example 30 μm. In addition, the microchannels may have a width (B2a) of ≧30 μm to ≦800 μm, in particular of ≧50 μm to ≦300 μm, for example 200 μm. Furthermore, the microchannels and/or the microelevations may have a length (L2) of ≧3 mm to ≦30 mm, in particular of ≧5 mm to ≦10 mm, for example 6 mm.

The electrodes of the interdigital electrode system may have a length (L1) of ≧3 mm to ≦30 mm, in particular of ≧5 mm to ≦10 mm, for example 6 mm, and/or a width (B1) of ≧10 μm to ≦500 μm, in particular of ≧50 μm to ≦200 μm, for example 100 μm or 200 μm, and/or a height (H1) of ≧0.1 μm to ≦50 μm, in particular of ≧20 μm to ≦30 μm, for example 25 μm. In addition, the electrodes of the interdigital electrode system may have a distance (D) to one another of ≧10 μm to ≦500 μm, in particular of ≧50 μm to ≦200 μm, for example 200 μm.

The cell may have a length (L3) of ≧10 mm to ≦80 mm, in particular of ≧20 mm to ≦50 mm, for example 40 mm, and/or a width (B3) of ≧3 mm to ≦40 mm, in particular of ≧5 mm to ≦10 mm, for example 6 mm, and/or a height (H3) of ≧20 μm to ≦1000 μm, in particular of ≧100 μm to ≦200 μm, for example 130 μm or 200 μm.

The flat electrode may have a length (L) of ≧10 mm to ≦100 mm, in particular of ≧20 mm to ≦60 mm, for example 40 mm, and/or a width (B) of ≧3 mm to ≦50 mm, in particular of ≧5 mm to ≦105 mm, for example 6 mm or 10 mm, and/or a height (H4) of ≧0.1 μm to ≦50 μm, in particular of ≧20 μm to ≦30 μm, for example 25 μm, and/or a surface area (L×B) of ≧30 mm² to ≦1800 mm², in particular of ≧100 mm² to ≦300 mm², for example 6 mm×40 mm.

For example, the ratio of height (H1) of the electrodes of the interdigital electrode system to height (H2) of the micromixer may be 1:2 to 1:100, and/or the ratio of height (H1) of the electrodes of the interdigital electrode system to height (H3) of the cell may be 1:10 to 1:1000, and/or the ratio of height (H2) of the micromixer to height (H3) of the cell may be 0.33:1 to 0.5:1.

The microfluidic cell may in particular be integrated into a microfluidic chip.

Moreover, the exemplary embodiments and/or exemplary methods of the present invention relates to a microfluidic system, for example a microfluidic chip, which includes a microfluidic cell according to the present invention.

A further subject matter of the exemplary embodiments and/or exemplary methods of the present invention is a method for the in particular dielectrophoretic separation and/or accumulation and/or lysis of polarizable bioparticles, for example bacteria and/or cells and/or viruses, using a microfluidic cell according to the present invention or a microfluidic system according to the present invention, which includes an accumulation phase, whereby a high-frequency alternating voltage, for example of ≧30 V to ≦50 V, having a frequency of ≧0.5 MHz to ≦1.5 MHz, for example 1 MHz, is being applied to the electrodes of the interdigital electrode system during the accumulation phase. A solution or suspension containing polarizable bioparticles, for example bacteria and/or cells and/or viruses, may be pumped through the microfluidic cell during the accumulation phase. The flat electrode may be kept in a floating state by the voltage during the accumulation phase. The flat electrode may be kept in a floating state by the voltage so it does not contact the flat electrode. In an electrical equivalent circuit diagram, this may be equivalent to a very high-impedance connection to ground having a (small) capacitor connected in parallel. As a result, a charge is able to build up on the flat electrode, and a voltage may develop. This voltage may be a function of the field conditions in the cell. The polarizable bioparticles may be released and/or washed out after being collected at the end of the accumulation phase by switching off the alternating voltage. A concentration effect may be advantageously achieved in this way.

Within another specific embodiment of the present invention, the method also includes a lysis phase, a low-frequency alternating voltage, for example of ≧30 V to ≦50 V, having a frequency of ≧1 kHz to ≦20 kHz, for example 10 kHz, being applied to the electrodes of the interdigital electrode system during the lysis phase. The pumps of the solution or suspension containing the polarizable bioparticles may be stopped during the lysis phase. The flat electrode may be kept in a floating state by the voltage also during the lysis phase. Following the lysis phase, the lysate may be rinsed out and/or reused.

Within the scope of another specific embodiment of the present invention, the method also includes a removal phase, in particular a DNA/RNA release phase, the electrodes of the interdigital electrode system being connected to ground, and a low-frequency alternating voltage or square wave voltage, for example of ≧50 mV to ≦150 mV, for example 100 mV, having a frequency of ≧0.1 Hz to ≦2 Hz, for example 1 Hz, and having a positive offset, for example of ≧10 mV to ≦100 mV, for example 50 mV, being applied to the flat electrode during the removal phase. Further polarizable bioparticles may be lysed in this phase. At the same time, as a result of the positive offset, negatively charged bioparticles, for example DNA, may be moved toward the flat electrode.

The lysis phase and the removal phase may in particular be carried out simultaneously. This may be achieved, for example, by applying a low-frequency alternating voltage, for example of ≧30 V to ≦50 V, having a frequency of ≧1 kHz to ≦20 kHz, for example 10 kHz, to the electrodes of the interdigital electrode system, and applying a low-frequency alternating voltage or square wave voltage, for example of ≧50 mV to ≦150 mV, for example 100 mV, having a frequency of ≧0.1 Hz to ≦2 Hz, for example 1 Hz, and having a positive offset, for example of ≧10 mV to ≦100 mV, for example 50 mV, to the flat electrode.

Moreover, the exemplary embodiments and/or exemplary methods of the present invention relates to the manufacture of a microfluidic cell according to the present invention and/or a microfluidic system according to the present invention. A microfluidic cell according to the present invention or a microfluidic system according to the present invention may in particular be manufactured by microtechnology processes. For example, a plate-shaped substrate, for example a glass substrate, a silicon substrate, or a polymer substrate, in particular a Pyrex substrate, an SU-8 substrate, a Teflon substrate, or a PDMS substrate, or a substrate structured by injection molding, deep etching, or stamping, in particular hot stamping, for example a structured glass substrate, silicon substrate, or polymer substrate, in particular a Pyrex substrate, SU-8 substrate, Teflon substrate, or PDMS substrate, may be used. Electrodes may then be attached thereto using thin-layer technology and/or lithography, for example. The resulting system may then be covered with a cap, for example a glass plate or a polymer plate, in particular a PDMS plate or a Pyrex plate.

Moreover, the exemplary embodiments and/or exemplary methods of the present invention relates to the use of a microfluidic cell according to the present invention and/or a microfluidic system according to the present invention in medical technology and microbiology, for example in medical analytics, in particular in an integrated microfluidic lab-on-a-chip system, for example for sample pretreatment, in particular for DNA and/or RNA analytics. For example, a lysate obtained using a cell according to the present invention or a system according to the present invention may be used for subsequent DNA or RNA analytics. In particular, pathogenic organisms may be concentrated prior to a subsequent analysis by using a cell according to the present invention or a system according to the present invention.

Further advantages and advantageous embodiments of the subject matters according to the exemplary embodiments and/or exemplary methods of the present invention are illustrated in the drawing and explained in the following description. It is pointed out that the drawing has only a descriptive character, and is not intended to limit the present invention in any way.

### BRIEF DESCRIPTION OF THE DRAWINGS

FIG. 1a shows a schematic perspective view of a first specific embodiment of a microfluidic cell according to the present invention having an interdigital electrode system and a flat electrode.

FIG. 1b shows a schematic enlarged view of the area shown in FIG. 1a and identified by a circle.

FIG. 2a shows a schematic cross section, along line A-A, through a second specific embodiment of a microfluidic cell according to the present invention having a combined interdigital electrode-micromixer system and a flat electrode.

FIG. 2b shows a schematic enlarged view of the area shown in FIG. 1a and identified by a circle.

FIG. 2c shows a schematic cross section, along line B-B, through the specific embodiment of a microfluidic cell according to the present invention shown in FIGS. 2a and 2b.

FIG. 2d shows a photograph of the combined interdigital electrode-micromixer system schematically shown in FIGS. 2a through 2c.

FIG. 3a shows a schematic cross section, along line A-A, through a third specific embodiment of a microfluidic cell according to the present invention having two interspaced, combined interdigital electrode-micromixer systems and a flat electrode.

FIG. 3b shows a schematic enlarged view of the area shown and 1.5 identified by a circle in FIG. 3a.

FIG. 4 shows a schematic cross section, along line B-B, through a fourth specific embodiment of a microfluidic cell according to the present invention in which the inlet and the outlet are integrated into the base plate.

FIG. 5 shows a block diagram for illustrating one possible activation of a microfluidic cell according to the present invention.

FIG. 6a shows a photograph of a fluorescent E. coli bacteria lysed in a microfluidic cell without a flat electrode.

FIG. 6b shows a photograph of a fluorescent E. coli bacteria lysed in a microfluidic cell with a flat electrode.

### DETAILED DESCRIPTION

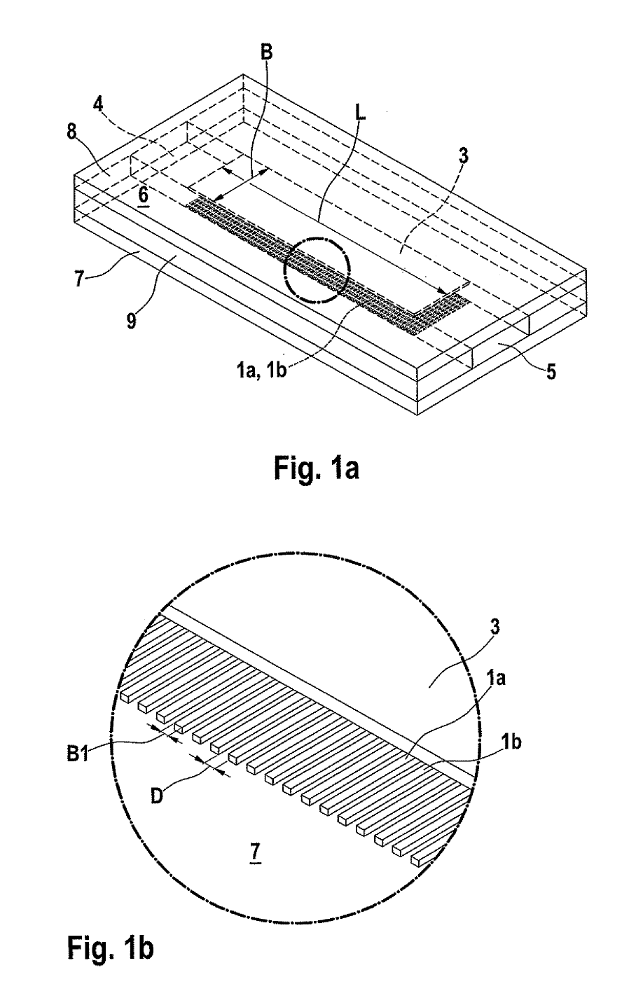

FIGS. 1a and 1b show a first specific embodiment of a microfluidic cell according to the present invention. The cell contains an interdigital electrode system composed of two electrode groups having interdigitally situated electrodes 1a and 1b and a flat electrode 3. Interdigital electrode system 1a and 1b and flat electrode 3 are situated on opposite sides of the cell. The surface area of flat electrode 3 essentially corresponds to the surface area of interdigital electrode system 1a, 1b. Electrodes 1a, 1b of the interdigital electrode system are configured and situated in the form of parallel straight stripes. FIGS. 1a and 1b also show that the cell has an inlet 4 and an outlet 5 and is integrated into a microfluidic chip 6. This chip 6 has unstructured bottom substrate 7 and barrier layer 9 on the side of the cell which is covered by a plate-shaped cap 8, thus forming a fluid channel.

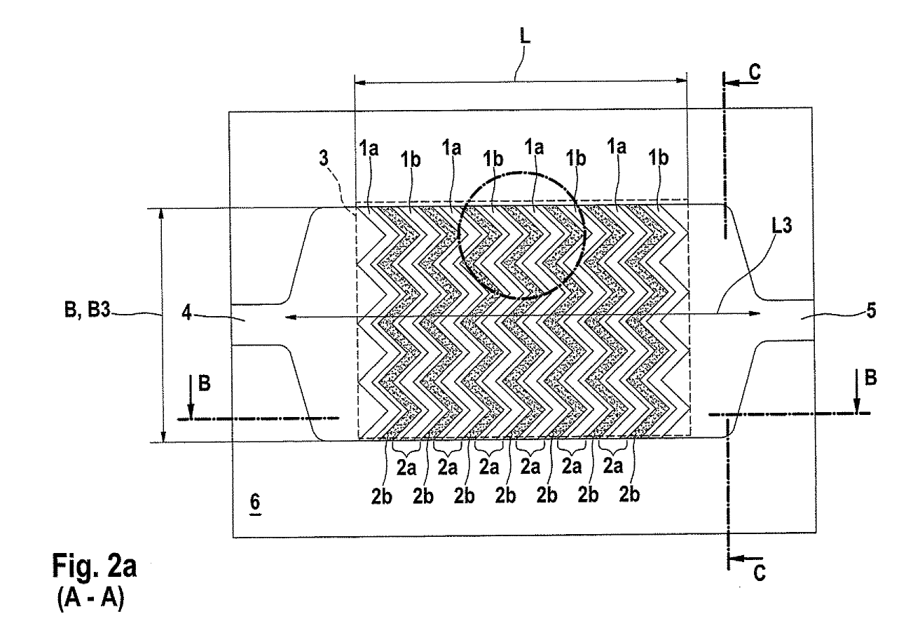

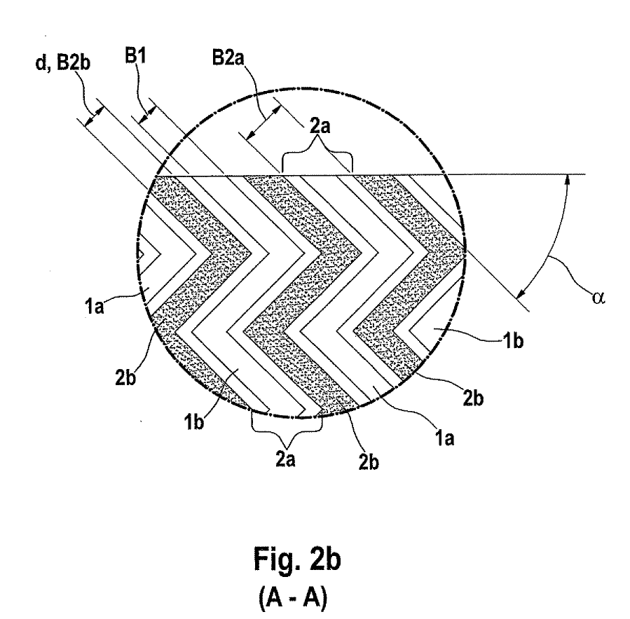

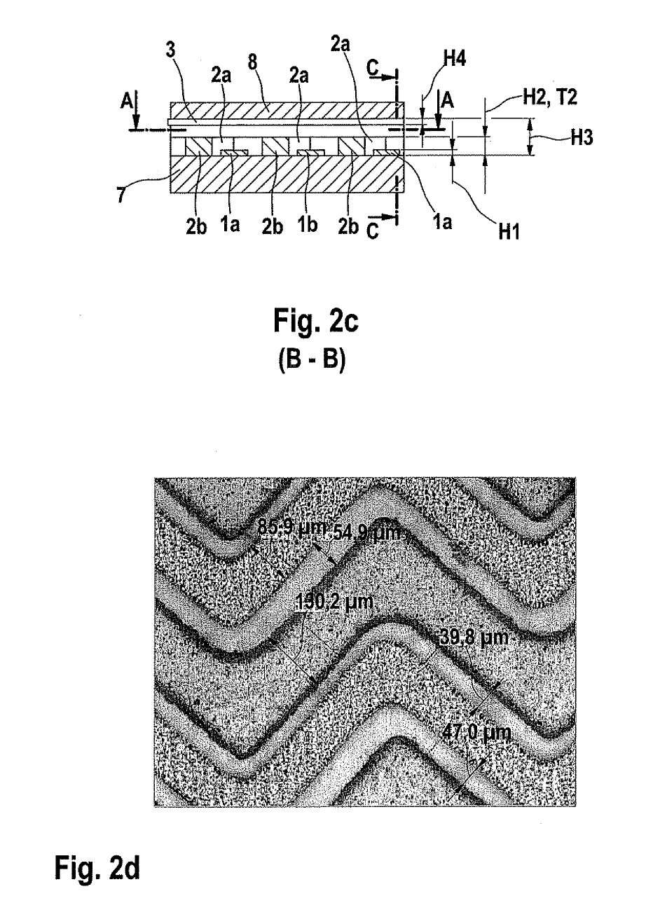

FIGS. 2a through 2d show a second specific embodiment of a microfluidic cell according to the present invention. The microfluidic cell includes an interdigital electrode system composed of two electrode groups having interdigitated electrodes 1a, 1b, and a micromixer having microchannels 2a and microelevations 2b. The interdigital electrode system and the micromixer are situated on the same side of the cell. FIGS. 1a through 1d also show that electrodes 1a, 1b of the interdigital electrode system are situated in microchannels 2a, and in this manner the interdigital electrode system and the micromixer form a combined interdigital electrode-micromixer system 1a, 1b, 2a, 2b. The surface area of flat electrode 3 essentially corresponds to the surface area of combined interdigital electrode-micromixer system 1a, 1b, 2a, 2b. Electrodes 1a, 1b of the interdigital electrode system, microchannels 2a, and microelevations 2b are configured in a zigzag shape and oriented parallel to one another, in particular in the shape of a symmetrical herringbone pattern. Electrodes 1a, 1b of the interdigital electrode system, microchannels 2a, and microelevations 2b are oriented at an angle α of 45° with respect to the flow direction.

FIG. 2c shows one specific embodiment of a microfluidic cell according to the present invention, having a structured (bottom) substrate 7 which is covered by plate-shaped cap 8, thus forming a fluid channel. Flat electrode 3 is mounted in particular on the bottom side of cap 8, and its dimensions essentially correspond to those of the active region of combined interdigital electrode-micromixer system 1a, 1b, 2a, 2b. Height (H2) of the micromixer is approximately ⅓ to ½ of height (H3) of the cell. Height (H1) of the electrodes, in turn, is much smaller than height (H2) of the micromixer.

FIG. 2d shows a first implementation of the first specific embodiment using printed circuit board technology. The substrate, micromixer, and electrodes are composed of a printed circuit board, structured solder resist, and metallic printed conductors. The side walls of the channel are implemented using double-sided adhesive tape. A glass plate was used as the cover. The flat electrode of the similar third specific embodiment is implemented using a flat indium-tin oxide (ITO) plating for the cover.

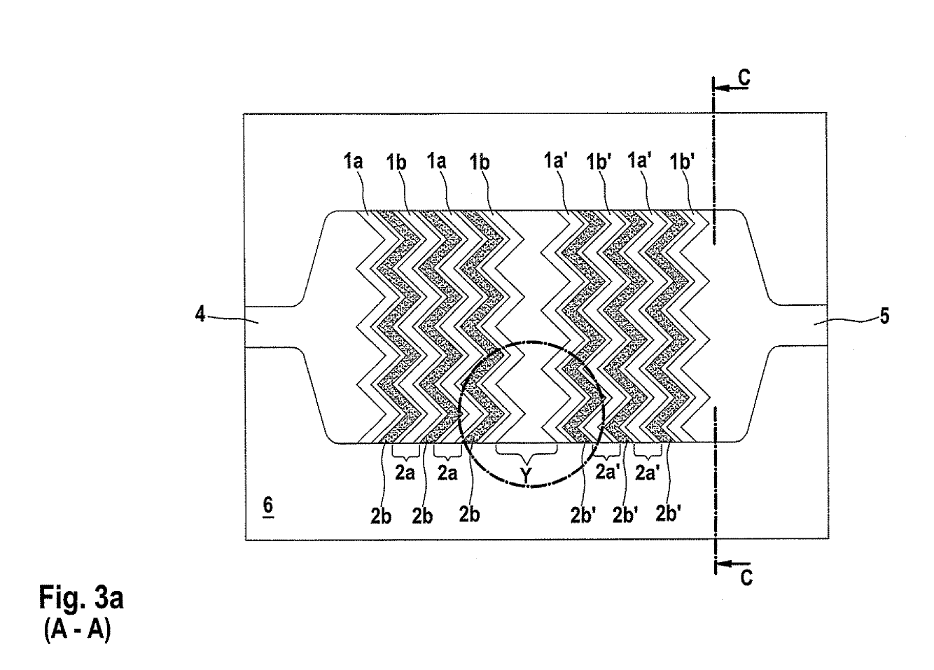

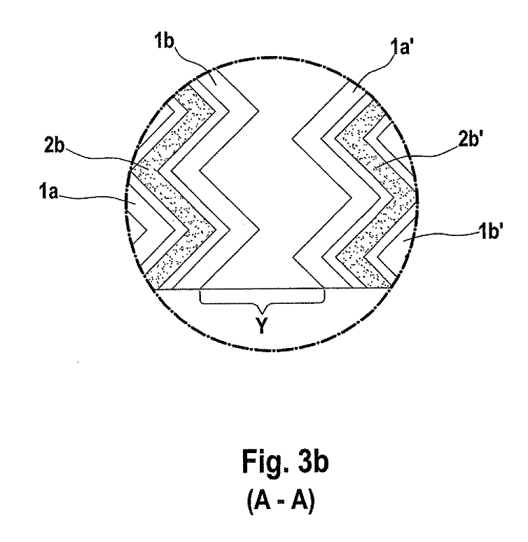

The third specific embodiment shown in FIGS. 3a and 3b differs from the second specific embodiment in that the microfluidic cell has two combined interdigital electrode-micromixer systems 1a, 1b, 2a, 2b; 1a′, 1b′, 2a′, 2b′ spaced at distance Y. FIGS. 3a and 3b show that the two combined interdigital electrode-micromixer systems 1a, 1b, 2a, 2b; 1a′, 1b′, 2a′, 2b′ differ by virtue of a different orientation. According to simulation, intermixture in the flow cell is further improved using this variant. FIGS. 3a and 3b also show that the surface area of flat electrode 3 essentially corresponds to the total surface area of the combined interdigital electrode-micromixer system 1a, 1b, 2a, 2b; 1a′, 1b′, 2a′, 2b′ and corresponds to spaced apart surface areas Y.

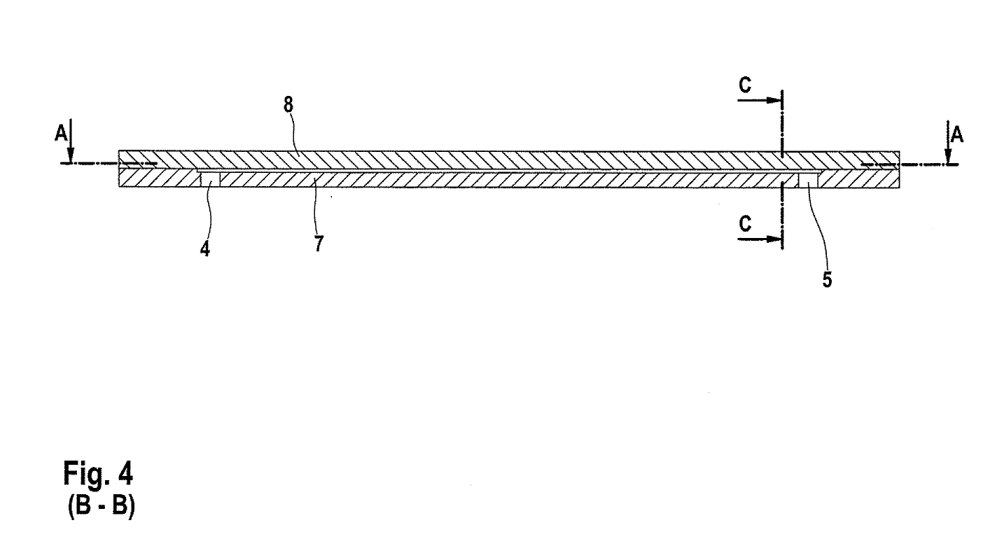

FIG. 4 shows a schematic cross section, along line B-B, through a fourth specific embodiment of a microfluidic cell according to the present invention in which inlet 4 and outlet 5 are integrated into the base plate.

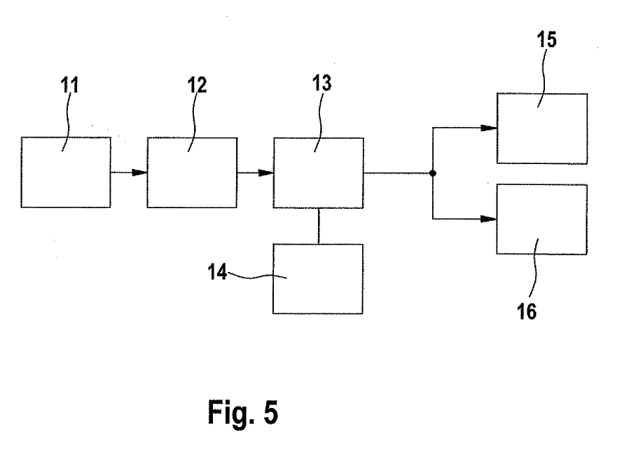

FIG. 5 is a block diagram for illustrating one possible activation of one specific embodiment of a microfluidic cell according to the present invention. During the accumulation phase a polarizable solution or suspension containing bioparticles such as bacteria, cells, and/or viruses is pumped from sample reservoir 11, with the aid of pump 12, through a microfluidic chip 13 into which a microfluidic cell is integrated. A high-frequency alternating voltage, for example of 30 V and 50 V and having a frequency of 1 MHz, is applied to electrodes 1a, 1b of the interdigital electrode system, adjacent electrodes 1a, 1b of the interdigital electrode system in each case having opposite polarities. Flat electrode 3 is kept in a floating state. The accumulation then takes place between electrodes 1a, 1b of the interdigital electrode system. Outlet 5, which in principle may be connected to a sample collection reservoir 15 and to a waste reservoir 16, is connected to waste reservoir 16.

During the lysis phase, pump 12 is first switched off. The polarizable bioparticles are then lysed by lowering the frequency of the alternating voltage at electrodes 1a, 1b of the interdigital electrode system to a low-frequency range, for example to 10 kHz. Flat electrode 3 is again kept in a floating state.

At the end, the lysate is rinsed out and may be reused.

After the lysis phase, an alternating voltage or square wave voltage, for example of 100 mV and having a frequency of 1 Hz, and having a positive offset, for example of 50 mV, may then be applied between flat electrode 3 and electrodes 1a, 1b of the interdigital electrode system. Further polarizable bioparticles may be lysed in this phase. At the same time, as a result of the positive offset voltage, for example, negatively charged DNA may be drawn from combined interdigital electrode-micromixer system 1a, 1b, 2a, 2b toward the center of the cell channel.

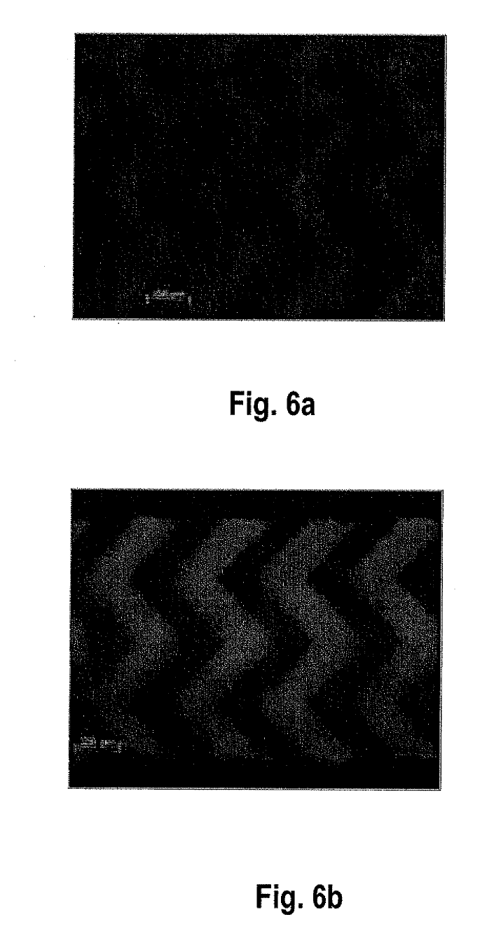

FIGS. 6a and 6b show photographs of accumulated and lysed fluorescent E. coli bacteria in a microfluidic cell without a flat electrode (6a) as well as a microfluidic cell with a flat electrode (6b) in deionized water at flow rates between 13 mL/min and 300 mL/min. Propidium iodide was used as stain. A comparison of FIGS. 6a and 6b also shows that the intensity of fluorescence is markedly increased in the microfluidic cell having flat electrode 3. This is attributed to the fact that, first, the lysis efficiency may be improved using flat electrode 3, and second, DNA may be removed from electrodes 1a, 1b of the interdigital electrode system as a result of the additionally applied voltage.

What is claimed is:

1. A microfluidic cell, comprising:
an interdigital electrode system composed of two electrode groups having interdigitated electrodes; and
a flat electrode, wherein the interdigital electrode system and the flat electrode are situated on opposite sides of the cell.

2. The microfluidic cell of claim 1, wherein a surface area of the flat electrode essentially corresponds to a surface area of the interdigital electrode system.

3. The microfluidic cell of claim 1, wherein the cell includes a micromixer having microchannels and microelevations.

4. The microfluidic cell of claim 3, wherein the interdigital electrode system and the micromixer are situated on a same side of the cell.

5. The microfluidic cell of claim 3, wherein electrodes of the interdigital electrode system are situated in the microchannels and form a combined interdigital electrode-micromixer system.

6. The microfluidic cell of claim 5, wherein the surface area of the flat electrode essentially corresponds to the surface area of the combined interdigital electrode-micromixer system.

7. The microfluidic cell of claim 3, wherein the micromixer is made of an insulating material.

8. The microfluidic cell of claim 1, wherein the electrodes of at least one of the interdigital electrode system, the microchannels, and the microelevations are configured and situated at least one of (i) in parallel to each other, (ii) at an angle (α) of ≧20° to ≦70° with respect to the flow direction, and (iii) in a zigzag shape or parallel slash mark pattern.

9. The microfluidic cell of claim 1, wherein the cell includes at least one of (i) at least one further interdigital electrode system composed of two electrode groups having interdigitated electrodes, and (ii) a further micromixer having microchannels and microelevations.

10. The microfluidic cell of claim 1, wherein at least one of the following is satisfied:
the combined interdigital electrode-micromixer system has a length of ≧10 mm to ≦60 mm,
the combined interdigital, electrode-micromixer system has a width of ≧3 mm to ≦30 mm,
the combined interdigital electrode-micromixer system has a surface area of ≧30 mm² to ≦1800 mm²,
at least one of the microchannels and the microelevations have a length of ≧3 mm to ≦30 mm,
the distance between two microchannels is between ≧30 μm and ≦500 μm,
the microchannels have a width of ≧30 μm to ≦800 μm,
the microelevations have a width of ≧30 μm to ≦500 μm,
the microelevations have a height of ≧10 μm to ≦400 μm,
the microchannels have a depth of ≧10 μm to ≦400 μm,
the electrodes of the interdigital electrode system have a length of ≧3 mm to ≦30 mm,
the electrodes of the interdigital electrode system have a width of ≧10 μm to ≦500 μm,
the electrodes of the interdigital electrode system have a height of ≧0.1 μm to ≦50 μm,
the electrodes of the interdigital electrode system have a distance to one another of ≧10 μm to ≦500 μm,
the cell has a length,
the cell has a width of ≧3 mm to ≦40 mm,
the cell has a height of ≧20 μm to ≦1000 μm,
the flat electrode has a length of ≧10 mm to ≦100 mm,
the flat electrode has a width of ≧3 mm to ≦50 mm,
the flat electrode has a height of ≧0.1 μm to ≦50 μm, and
the flat electrode has an area of ≧30 mm² to ≦1800 mm².

11. A microfluidic system, comprising:
a microfluidic cell, including:
an interdigital electrode system composed of two electrode groups having interdigitated electrodes; and
a flat electrode, wherein the interdigital electrode system and the flat electrode are situated on opposite sides of the cell.

12. A method for at least one of separating and accumulating polarizable bioparticles, the method comprising:
using a microfluidic cell, including:
an interdigital electrode system composed of two electrode groups having interdigitated electrodes, and
a flat electrode, wherein the interdigital electrode system and the flat electrode are situated on opposite sides of the cell;
performing an accumulation phase, wherein a high-frequency alternating voltage is applied to the electrodes of the interdigital electrode system during the accumulation phase, and the flat electrode is kept in a floating state by the voltage.

13. The method of claim 12, further comprising:
performing a lysis phase, wherein a low-frequency alternating voltage is applied to the electrodes of the interdigital electrode system during the lysis phase, and wherein the flat electrode is kept in a floating state by the voltage.

14. The method of claim 12, further comprising:
performing a removal phase, wherein the electrodes of the interdigital electrode system are connected to ground, and wherein one of a low-frequency alternating voltage and a square wave voltage having a positive offset is applied to the flat electrode during the removal phase.

15. An integrated microfluidic lab-on-a-chip system, comprising:
a microfluidic cell for at least one of dielectrophoretic separation, accumulation, and lysis of polarizable bioparticles, including:
an interdigital electrode system composed of two electrode groups having interdigitated electrodes; and
a flat electrode, wherein the interdigital electrode system and the flat electrode are situated on opposite sides of the cell.

16. The microfluidic cell of claim 1, wherein the microfluidic cell is a flow cell for at least one of dielectrophoretic separation, accumulation, and lysis of polarizable bioparticles.

17. The microfluidic cell of claim 1, wherein the microfluidic cell is a flow cell for at least one of dielectrophoretic separation, accumulation, and lysis of polarizable bioparticles, which includes at least one of bacteria, cells and viruses.
